(19) United States
(12) Patent Application Publication
(10) Pub. No.: US 2026/0079770 A1
(43) Pub. Date: Mar. 19, 2026

(54) AI AGENT FOR DOWNSTREAM PRESCRIPTIVE AI MODEL

(71) Applicant: International Business Machines Corporation, Armonk, NY (US)

(72) Inventors: Wei Sun, Yorktown Heights, NY (US); Linh Tran, Troy, NY (US); Zhengliang Xue, Yorktown Heights, NY (US); Markus Ettl, Yorktown Heights, NY (US); Youssef Drissi, Yorktown Heights, NY (US); Shivaram Subramanian, Coppell, TX (US); Herbert Scott McFaddin, Yorktown Heights, NY (US)

(21) Appl. No.: 18/887,696

(22) Filed: Sep. 17, 2024

(51) Int. Cl. G06F 9/54; G06F 40/30

(52) U.S. Cl. CPC G06F 9/54; G06F 40/30

(57) ABSTRACT

An example operation may include one or more of receiving at least one natural language input via a software application, determining that the at least one natural language input matches an application programming interface (API) call from among a plurality of API calls configured for prescriptive tasks, identifying at least one parameter value of the API call from the at least one natural language input and transmitting the API call to a prescriptive artificial intelligence (AI) model, executing the prescriptive AI model on the at least one parameter value to generate a natural language response, and displaying the natural language response via a graphical user interface (GUI) of the software application.

### BACKGROUND

A prescriptive artificial intelligence (AI) model uses a combination of machine learning, causal predictive models, and optimization models to suggest actions that can help achieve a desired outcome. Usability of prescriptive AI models remains a significant and pervasive obstacle because end users typically do not have the skills to operate these AI models. Furthermore, data science groups and business-focused end users often work in silos, impeding swift execution. In addition, prescriptive AI models are typically domain-specific, and are trained with application-dependent data, which is absent from standard training data of other artificial intelligence models such as large language models (LLMs).

### SUMMARY

One example embodiment provides a computer-implemented method that includes one or more of receiving at least one natural language input via a software application, determining that the at least one natural language input matches an application programming interface (API) call from among a plurality of API calls configured for prescriptive, identifying at least one parameter value of the API call from the at least one natural language input and transmitting the API call to a prescriptive artificial intelligence (AI) model, executing the prescriptive AI model on the at least one parameter value to generate a natural language response, and displaying the natural language response via a graphical user interface (GUI) of the software application.

Another example embodiment provides a computer system that may include a processor set, a set of one or more computer-readable storage media, and program instructions, collectively stored in the set of one or more storage media, for causing the processor set to perform one or more of receive at least one natural language input via a software application, determine that the at least one natural language input matches an application programming interface (API) call from among a plurality of API calls configured for prescriptive tasks, identify at least one parameter value of the API call from the at least one natural language input and transmit the API call to a prescriptive artificial intelligence (AI) model, execute the prescriptive AI model on the at least one parameter value to generate a natural language response, and display the natural language response via a graphical user interface (GUI) of the software application.

A further example embodiment provides a computer program product that may include a set of one or more computer-readable storage media, and program instructions, collectively stored in the set of one or more computer-readable storage media, for causing a processor set to perform computer operations including one or more of receiving at least one natural language input via a software application, determining that the at least one natural language input matches an application programming interface (API) call from among a plurality of API calls configured for prescriptive tasks, identifying at least one parameter value of the API call from the at least one natural language input and transmitting the API call to a prescriptive artificial intelligence (AI) model, executing the prescriptive AI model on the at least one parameter value to generate a natural language response, and displaying the natural language response via a graphical user interface (GUI) of the software application.

### BRIEF DESCRIPTION OF THE DRAWINGS

FIG. 1 is a diagram illustrating a computing environment according to an embodiment of the instant solution.

FIG. 2A is a system diagram illustrating an AI agent and downstream prescriptive AI models according to the examples and features of the instant solution.

FIG. 2B is a diagram illustrating a detailed view of the AI agent according to the examples and features of the instant solution.

FIG. 2C is a diagram illustrating a process of filling slots of an API call using the AI agent according to examples and features of the instant solution.

FIG. 2D is a diagram illustrating a process of generating a response to the API call and submitting the response to a software application according to examples and features of the instant solution.

FIG. 2E is a diagram illustrating a process of generating additional dialog when an intent cannot be determined according to examples and features of the instant solution.

FIG. 2F is a diagram illustrating a process of identifying missing parameters from an API call according to examples and features of the instant solution.

FIG. 3A is a system diagram illustrating integration of an AI model into any decision point according to the examples and features of the instant solution.

FIG. 3B is a diagram illustrating a process for developing an AI model that supports AI-assisted computer decision points according to the examples and features of the instant solution.

FIG. 3C is a diagram illustrating a process for utilizing an AI model that supports AI-assisted computer decision points according to examples and features of the instant solution.

FIG. 4A is a diagram illustrating a process of generating a response to a natural language query according to examples of the features of the instant solution.

FIG. 4B is a diagram illustrating an example of a conversation performed using the AI agent described herein according to examples of the features of the instant solution.

FIG. 5A illustrates a flow diagram, according to example embodiments.

FIG. 5B illustrates a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a computer-implemented method that includes receiving at least one natural language input via a software application, determining that the at least one natural language input matches an application programming interface (API) call from among a plurality of API calls configured for prescriptive tasks including causal analysis and decision-making, identifying at least one parameter value of the API call from the at least one natural language input and transmitting the API call to a prescriptive artificial intelligence (AI) model, executing the prescriptive AI model on the at least one parameter value to generate a natural language response, and displaying the natural language response via a graphical user interface (GUI) of the software application. The technical effect of this feature is that communication between an end user and a downstream AI model, such as a prescriptive AI model, is enhanced. The plurality of API calls correspond to a plurality of AI models which can each generate a response to the user's query. In this case, the method ensures that the necessary data for executing a downstream AI model, corresponding to the API call, is present by identifying the parameter value of the API call from the at least one natural language input.

In some embodiments, the computer-implemented method further includes determining that a first natural language input does not match any of the plurality of API calls, and in response, executing a large language model (LLM) on the at least one parameter value to generate additional dialog and outputting the additional dialog via the GUI of the software application. The technical advantage of this feature is that the method can detect when the query does not match any of the predefined AI models and that more data is needed before the method can generate a response to the query. To do this, the method generates additional dialog for the end user enabling additional data to be provided to determine intent of the user and ultimately determine the AI model to execute.

In some embodiments, the computer-implemented method includes determining that the query corresponds to an API call based on a first large language model (LLM) that interprets the intent behind the natural language input, and slot filling the API call based on a second LLM that extracts the necessary parameters from the natural language input to configure the API call. The technical effect of this feature is that the method can match the query to an API call using an intent classification LLM, and then fill the API call with parameter values using a slot-filling LLM thereby enabling the API call to be executed.

In some embodiments, the computer-implemented method includes identifying a required parameter value of the API call that is missing from the at least one natural language input, and in response, identifying the required parameter value from prior conversation state stored within a memory and executing the prescriptive AI model on the required parameter value to generate the natural language response. The technical advantage of this feature is that the method can avoid additional dialog with the end user when the necessary data for generating a response to the query is not present from the state of the conversation by looking for the necessary data from prior state data stored in the memory.

In some embodiments, the computer-implemented method further includes identifying a required parameter value of the API call that is missing from a first natural language input, and in response, executing a large language model (LLM) on the first natural language input to generate additional dialog and outputting the additional dialog via the GUI of the software application. The technical advantage of this feature is that the method can identify that the user has not provided enough data to generate a response using an AI model, and can automatically generate additional dialog for obtaining the necessary data using a LLM.

In some embodiments, the computer-implemented method further includes receiving a second natural language input via the software application, aggregating the first natural language input with the second natural language input to generate an aggregated input, and identifying the required parameter value from the aggregated input. The technical advantage of this feature is that the method can use additional dialog to obtain the necessary data for executing a downstream AI model and use the necessary data provided in response to the additional dialog to generate a response to the end user's query.

In some embodiments, the computer-implemented method further includes matching the at least one natural language input to the API call from among the plurality of API calls based on execution of a large language model (LLM) on the at least one natural language input. The technical advantage of this feature is that artificial intelligence can be used to determine an intent of an end user from among a plurality of predefined intents, and execute a downstream AI model corresponding to the intent to provide a response to the end user based on the user's intent.

According to an aspect of the example embodiments, there is provided a computer system that includes a processor set, a set of one or more computer-readable storage media, and program instructions, collectively stored in the set of one or more storage media, for causing the processor set to perform computer operations including receiving at least one natural language input via a software application, determining that the at least one natural language input matches an application programming interface (API) call from among a plurality of API calls configured for prescriptive tasks including causal analysis and decision-making, identifying at least one parameter value of the API call from the at least one natural language input and transmitting the API call to a prescriptive artificial intelligence (AI) model, executing the prescriptive AI model on the at least one parameter value to generate a natural language response, and displaying the natural language response via a graphical user interface (GUI) of the software application. The technical effect of this feature is that communication between an end user and a downstream AI model, such as a prescriptive AI model, is enhanced. The plurality of API calls correspond to a plurality of AI models which can each generate a response to the user's query. In this case, the system ensures that the necessary data for executing a downstream AI model, corresponding to the API call, is present by identifying the parameter value of the API call from the at least one natural language input.

In some embodiments, the computer operations further include determining that a first natural language input does not match any of the plurality of API calls, and in response, executing a large language model (LLM) on the at least one parameter value to generate additional dialog and outputting the additional dialog via the GUI of the software application. The technical advantage of this feature is that the system can detect when the query does not match any of the predefined AI models and that more data is needed before the system can generate a response to the query. To do this, the system generates additional dialog for the end user enabling additional data to be provided to determine the intent of the user and ultimately determine the AI model to execute.

In some embodiments, the computer operations include determining that the query corresponds to an API call based on a first large language model (LLM) that interprets the intent behind the natural language input, and slot filling the API call based on a second LLM that extracts the necessary parameters from the natural language input to configure the API call. The technical effect of this feature is that the method can match natural language input to an API call using an intent classification LLM, and then fill the API call with parameter values using a slot-filling LLM thereby enabling the API call to be executed.

In some embodiments, the computer operations further include identifying a required parameter value of the API call that is missing from the at least one natural language input, and in response, identifying the required parameter value from prior conversation state stored within a memory and executing the prescriptive AI model on the required parameter value to generate the natural language response. The technical advantage of this feature is that the system can avoid additional dialog with the end user when the necessary data for generating a response to the query is not present from the state of the conversation by looking for the necessary data from prior state data stored in the memory.

In some embodiments, the computer operations further include identifying a required parameter value of the API call that is missing from a first natural language input, and in response, executing a large language model (LLM) on the first natural language input to generate additional dialog and outputting the additional dialog via the GUI of the software application. The technical advantage of this feature is that the system can identify that the user has not provided enough data to generate a response using an AI model, and can automatically generate additional dialog for obtaining the necessary data using a LLM.

In some embodiments, the computer operations further include receiving a second natural language input via the software application and aggregating the first natural language input with the second natural language input to generate an aggregated input, wherein the identifying comprises identifying the required parameter value from the aggregated input. The technical advantage of this feature is that the system can use additional dialog to obtain the necessary data for executing a downstream AI model and use the necessary data provided in response to the additional dialog to generate a response to the end user's query.

In some embodiments, the computer operations further include matching the at least one natural language input to the API call from among the plurality of API calls based on execution of a large language model (LLM) on the at least one natural language input. The technical advantage of this feature is that artificial intelligence can be used by the system to determine an intent of an end user from among a plurality of predefined intents, and execute a downstream AI model corresponding to the intent to provide a response to the end user based on the user's intent.

According to an aspect of the example embodiments, there is provided a computer program product that includes a set of one or more computer-readable storage media, and program instructions, collectively stored in the set of one or more computer-readable storage media, for causing a processor set to perform computer operations that include receiving at least one natural language input via a software application, determining that the at least one natural language input matches an application programming interface (API) call from among a plurality of API calls configured for prescriptive tasks including causal analysis and decision-making, identifying at least one parameter value of the API call from the at least one natural language input and transmitting the API call to a prescriptive artificial intelligence (AI) model, executing the prescriptive AI model on the at least one parameter value to generate a natural language response, and displaying the natural language response via a graphical user interface (GUI) of the software application. The technical effect of this feature is that communication between an end user and a downstream AI model, such as a prescriptive AI model, is enhanced. The plurality of API calls correspond to a plurality of AI models which can each generate a response to the user's query. In this case, the computer program product ensures that the necessary data for executing a downstream AI model, corresponding to the API call, is present by identifying the parameter value of the API call from the at least one natural language input.

In some embodiments, the computer operations further include determining that a first natural language input does not match any of the plurality of API calls, and in response, executing a large language model (LLM) on the at least one parameter value to generate additional dialog and outputting the additional dialog via the GUI of the software application. The technical advantage of this feature is that the computer program product can detect when the query does not match any of the predefined AI models and that more data is needed before the system can generate a response to the query. To do this, the computer program product generates additional dialog for the end user enabling additional data to be provided to determine intent of the user and ultimately determine the AI model to execute.

In some embodiments, the computer operations include determining that the query corresponds to an API call based on a first large language model (LLM) that interprets the intent behind the natural language input, and slot filling the API call based on a second LLM that extracts the necessary parameters from the natural language input to configure the API call. The technical effect of this feature is that the method can match the natural language input to an API call using an intent classification LLM, and then fill the API call with parameter values using a slot-filling LLM thereby enabling the API call to be executed.

In some embodiments, the computer operations further include identifying a required parameter value of the API call that is missing from the at least one natural language input, and in response, identifying the required parameter value from prior conversation state stored within a memory and executing the AI model on the required parameter value to generate the natural language response. The technical advantage of this feature is that the computer program product can avoid additional dialog with the end user when the necessary data for generating a response to the query is not present from the state of the conversation by looking for the necessary data from prior state data stored in the memory.

In some embodiments, the computer operations further include identifying a required parameter value of the API call that is missing from a first natural language input, and in response, executing a large language model (LLM) on the first natural language input to generate additional dialog and outputting the additional dialog via the GUI of the software application. The technical advantage of this feature is that the computer program product can identify that the user has not provided enough data to generate a response using an AI model, and can automatically generate additional dialog for obtaining the necessary data using a LLM.

In some embodiments, the computer operations further include receiving a second natural language input via the software application and aggregating the first natural language input with the second natural language input to generate an aggregated input, wherein the identifying comprises identifying the required parameter value from the aggregated input. The technical advantage of this feature is that the computer program product can use additional dialog to obtain the necessary data for executing a downstream AI model and use the necessary data provided in response to the additional dialog to generate a response to the end user's query.

The example embodiments are directed to an agent system that includes at least one large language model (LLM) for identifying an intent of a natural language query. The intent is limited to a plurality of possible functions to be executed on the natural language query. Here, the functions are API calls that can be sent to downstream AI models, such as prescriptive AI models, which can generate a natural language response to the natural language query. The agent system can ensure that the downstream AI models have the necessary data for generating an accurate response to the natural language query using the at least one LLM. For example, the at least one LLM can fill empty slots (parameters) of a function to be executed by a downstream AI model ensuring that all of the necessary parameters of the function are present. If a parameter is not present, the at least one LLM can obtain the missing parameter value from memory (previous conversation state), additional dialog with the end user, and the like.

In situations where the agent system determines that there is not enough data to make an API call, or there is not enough data to complete the API call (e.g., missing parameter values), the agent system may generate additional dialog to draw out additional information of the user to determine the API call and/or determine the missing parameter values. This process may be iteratively performed in a loop until the agent system is confident about the API call and has the requisite data necessary for the API call. The process ensures that all necessary data to be used by the downstream AI model/prescriptive AI model is obtained prior to making the API call and generating the response. The agent system may be hosted on a cloud computing platform, a web server, a combination of systems, and the like.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

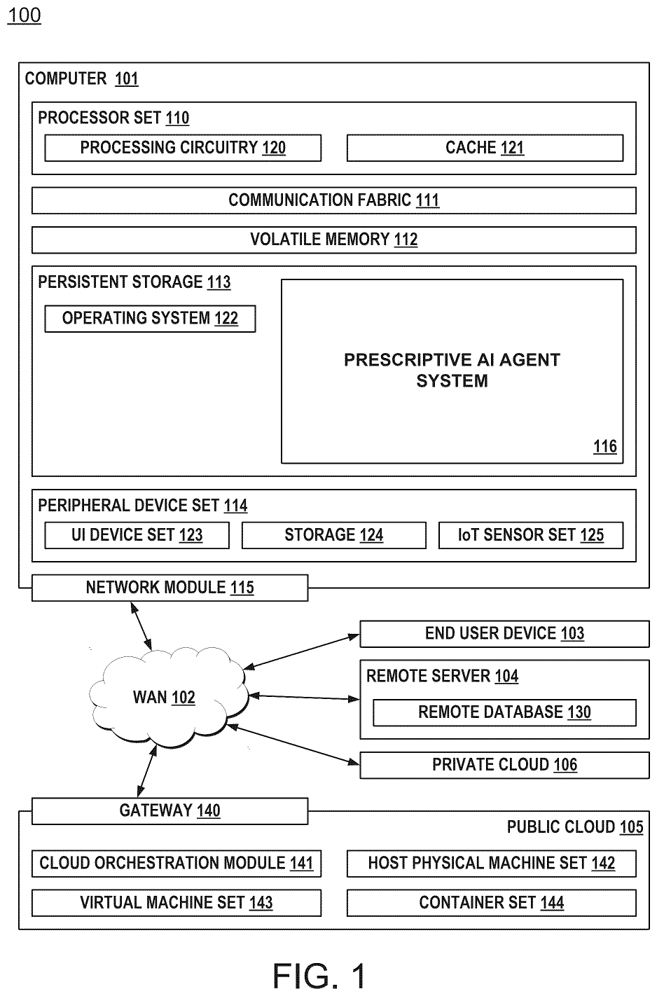

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a prescriptive AI agent system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

The example embodiments are directed to an AI agent that can be hosted on a cloud platform, such as the cloud platform described with respect to FIG. 1. The AI agent includes LLMs (and other AI models), tools in terms of API function calls from downstream prescriptive AI models, and a memory. When a user inputs a query, the AI agent (powered by LLMs) may determine whether one of the pre-defined API calls needs to be made based on the input. The pre-defined API calls may be configured for prescriptive tasks including causal analysis and decision-making. Under the hood, the LLMs perform several NLP tasks including intent classification as well as slot filling. More specifically, the intent of a query may be mapped to one of the pre-defined API calls, while slot filling identifies various parameters or arguments to be used in the matched API call. When an LLM identifies an API call and/or parameters, these values are written into a customized memory module.

Based on the output from the LLMs, there are different possible scenarios the AI agent can perform including determining that the query is indicating a specific API call and the necessary input arguments are present. In this case, the API function call will be executed. In another scenario, the AI agent may determine that the user is asking for an API call, but one or more parameters/arguments necessary for filling the slots of the API call function are missing. In this case, the AI agent may first go into a memory to see if the missing parameters can be retrieved from the earlier conversations. If so, the agent may proceed to call the specific API. However, if the AI agent is unable to locate the necessary parameters in the memory, the AI agent can ask a follow-up question to the user for that information. In another scenario, the AI agent may determine that the user query is not related to any of the pre-defined API calls (e.g., there is not enough information to select an API call from among the plurality of API calls.) In this case, the AI agent may generate additional follow-up question(s) and output them to the user via the conversation.

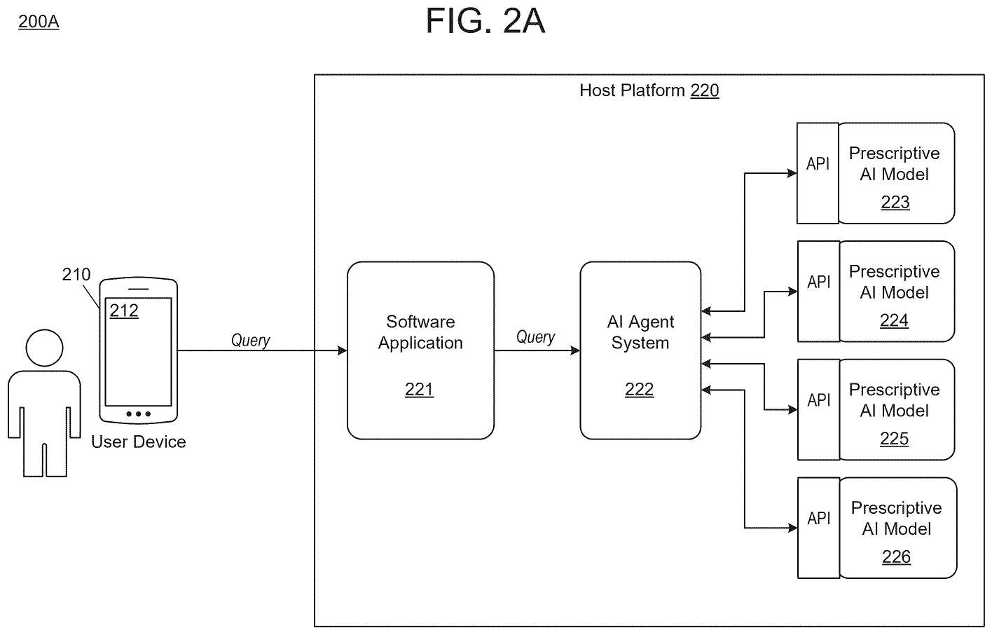

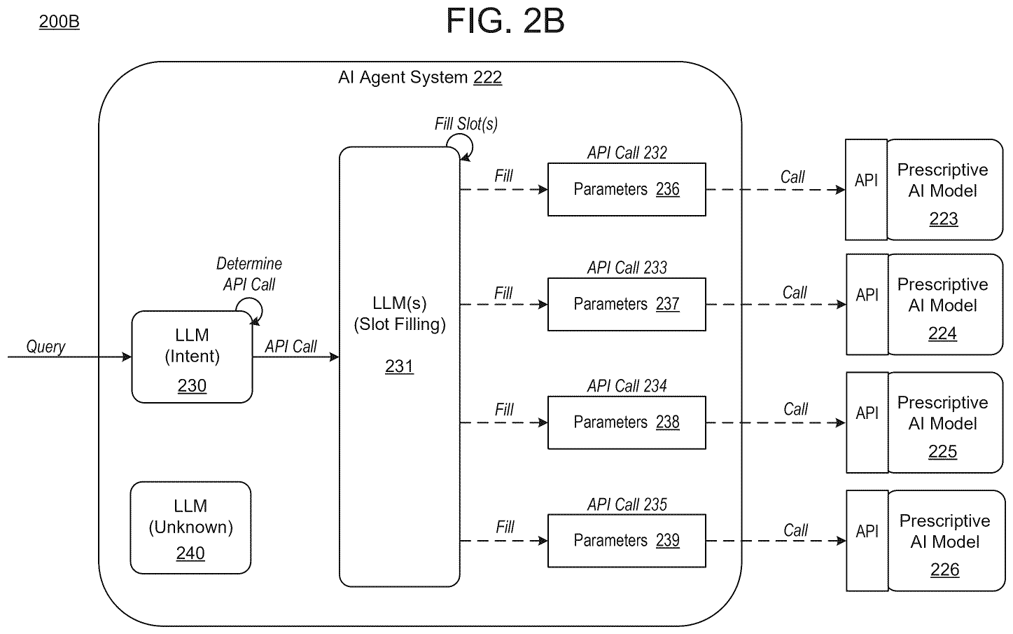

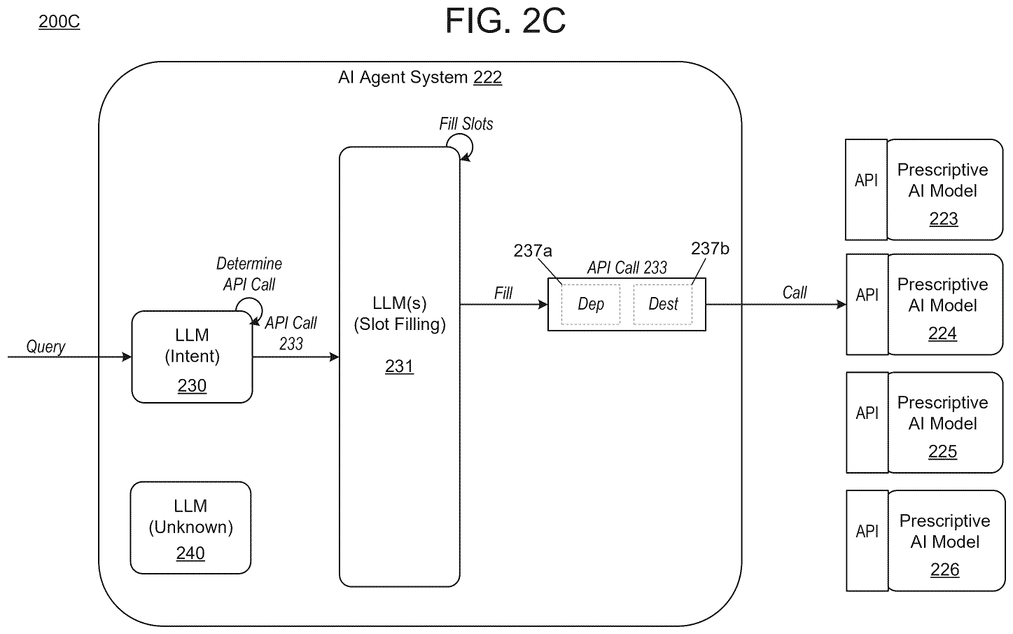

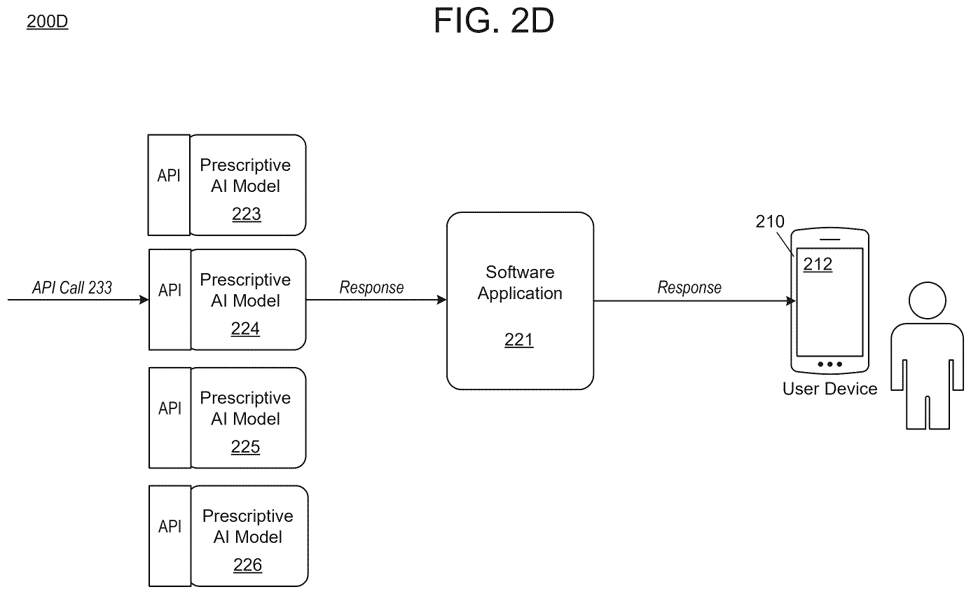

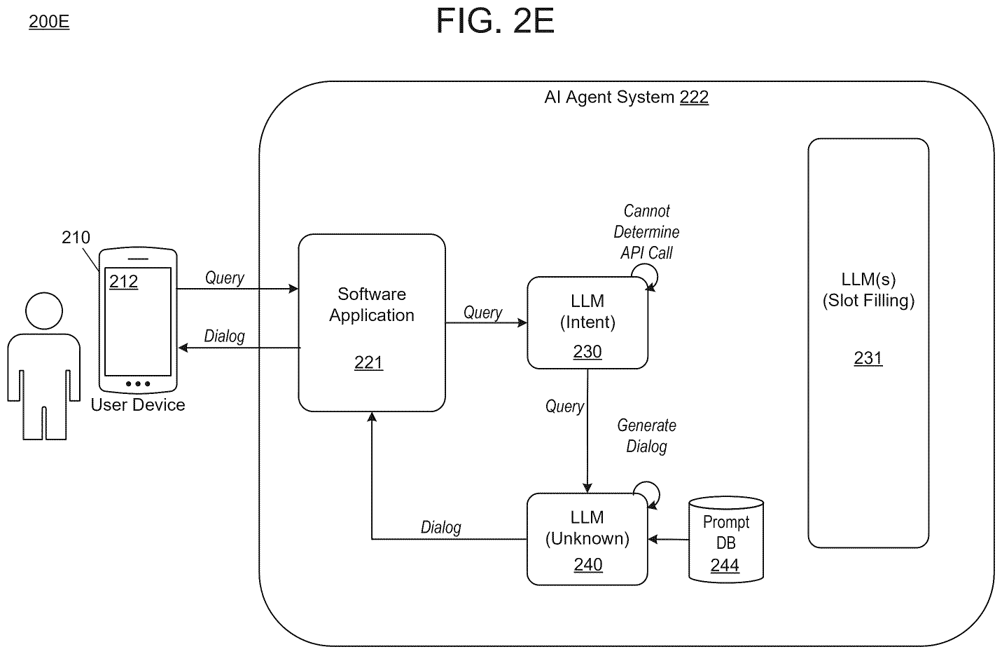

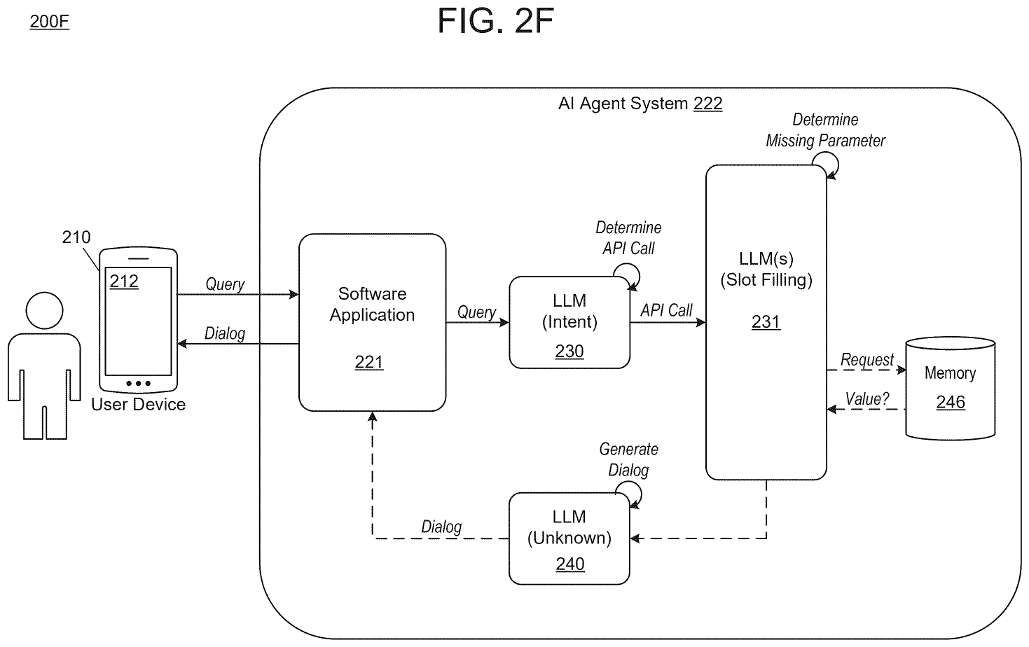

FIG. 2A illustrates a system 200A that includes an AI agent or AI agent system 222 and a plurality prescriptive AI models 223, 224, 225, and 226 which are downstream from the AI agent 222 according to the examples and features of the instant solution. Referring to FIG. 2A, a host platform 220 may host a software application 221 which provides chat capabilities, for example, via a chat window of the software application. In some embodiments, the software application 221 may receive natural language inputs (queries) from a user and provide a natural language response to the user. In some cases, the software application 221 may utilize a chatbot or other avatar to output the responses. The software application 221 may be any kind of software that uses artificial intelligence. The natural language input may be related to causal analysis and/or decision making. The software application may present the response via a graphical user interface (GUI). The response may include a natural language response and visual aids such as graphs, charts, interactive plots, and the like, which can enhance the user's understanding and facilitate decision-making.

The user may use a computing system such as a user device 210 to connect to the host platform 220 over a computer network such as the Internet. In this case, the user device 210 may access the software application 221 through a browser on the user device 210. For example, a user may enter a web address of the software application 221 into the browser which causes the browser to navigate to the web address/landing page of the software application 221. As another example, the software application 221 may include a front-end that is downloaded and installed on the user device 210 and which communicates directly with the software application 221 (e.g., a back-end) on the host platform 220. Here, the user device 210 includes a display screen 212 which may display a graphical user interface (GUI) of the software application 221, which may include a chat window.

According to various embodiments, the user device 210 may submit a query (natural language input) to the software application 221, for example, by a user of the user device 210 typing the query into a window of the GUI displayed on the display screen 212. As another example, the user device 210 may receive audio spoken by the user, convert the audio into text, and transmit the text as the query/natural language input. In response to receiving the query, the software application 221 may pass the query to the AI agent 222. The AI agent 222 may determine how best to proceed with the query. For example, the AI agent 222 may determine that enough data is present to call a prescriptive AI model from among the plurality of prescriptive AI models 223, 224, 225, and 226. As another option, the AI agent 222 may determine that not enough data is present to make such a call, and may generate additional dialog that can be used to draw out the necessary/missing data. The additional dialog can be output to the user device 210, for example, via the GUI, etc.

FIG. 2B illustrates a detailed view 200B of the AI agent 222 according to the examples and features of the instant solution. For example, the AI agent 222 may include a plurality of AI models, such as large language models (LLMs) which perform various roles including intent identification, slot filling of function calls, and the like. Referring to FIG. 2B, the query provided from the user may be transferred to the software application 221 (shown in FIG. 2A), and input to the AI agent 222. In this example, a LLM 230 receives the query and determines whether or not the query matches an API call from among a plurality of API calls 232, 233, 234, and 235. The plurality of API calls 232, 233, 234, and 235 are used to call the plurality of prescriptive AI models 223, 224, 225, and 226. As an example, the plurality of prescriptive AI models 223, 224, 225, and 226 may correspond to different types of queries that require different types of analysis.

As an example, a prescriptive AI model 223 may determine an optimized pricing policy for airline tickets. In order for the prescriptive AI model 223 to make such a determination, it requires a departure location and an arrival location. These two locations (departure and destination) may be parameters 236 that are necessary for making the corresponding API call (API call 232). When the LLM 230 determines that the query corresponds to the API call 232, the LLM 230 may call a second LLM 231 which determines whether the parameters are available for filling slots of the API call 232. In this case, the slots correspond to the departure location and the destination location. If present, the LLM 231 may fill the slots, and then execute the API call 232 thereby calling the downstream prescriptive AI model with the requisite data necessary for generating a response to the user's query.

In the example of FIG. 2B, there are four different API calls (the plurality of API calls 232, 233, 234, and 235) which each have their own parameters for making the calls (e.g., parameters 236, 237, 238 and 239, respectively). In some cases, only a single API call is generated by the process. However, in some embodiments, multiple API calls may be generated by a single natural language input. As another example, a result of an API call and a response may require an additional API call and an additional response to be generated.

The LLM 230 that is responsible for determining whether the query matches an API call may be trained to identify text content that is related to specific query types that are handled by the different prescriptive AI models. For example, a first prescriptive AI model may generate an optimum pricing policy for a flight, a second prescriptive AI model may provide answers to “what if” questions about pricing, a third prescriptive AI model may show a current or historical pricing policy, a fourth prescriptive AI model may return revenue generated by a given pricing policy, a fifth prescriptive AI model may return a price conversion from one currency into another, and so forth. These types of query types are domain specific and will be different depending on the domain where the AI agent 222 and the prescriptive AI models are being used, and should not be construed as being limited to pricing of airline tickets.

FIG. 2C illustrates a process 200C of filling slots of an API call using the AI agent 222 according to examples and features of the instant solution. Referring to FIG. 2C, the LLM 230 determines that the input query matches the API call 233 corresponding to the prescriptive AI model 224. In this case, the LLM 230 provides an identifier of the API call 233 to the LLM 231 along with the query. In response, the LLM 231 attempts to find the parameter values that are necessary for filling the API call 233. Here, a slot 237a and a slot 237b correspond to parameter values that are needed to perform the API call 233.

In this example, the LLM 231 may search the natural language query and find the parameter values for the slot 237a and the slot 237b, and insert the parameter values into slots to generate the function call (API call 233). When the slots are filled, the LLM 231 may trigger execution of the API call 233 which calls the downstream prescriptive AI model 224, and requests the prescriptive AI model 224 to generate a response to the query. In this example, the parameter values input into the slots are input to the prescriptive AI model 224 and used to generate a predicted result.

FIG. 2D illustrates a process 200D of generating a response to the API call 233 submitted in FIG. 2C, and outputting the response to the software application 221 according to examples and features of the instant solution. Each of the prescriptive AI models from among the plurality of prescriptive AI models 223, 224, 225, and 226 may be configured to generate different types of responses to different types of queries, respectively, and output the responses via the software application 221.

The responses may be natural language outputs, visual data such as charts, graphs, etc., and the like. Each of the prescriptive AI models 223, 224, 225, and 226 may be in communication with the software application 221, and can generate outputs which are then transferred to the software application 221. In response, the software application 221 can output the responses to a GUI or other window of the software application 221 which is being accessed by, viewed, etc., by the user device 210 using the display screen 212.

FIG. 2E illustrates a process 200E of generating additional dialog when an intent cannot be determined according to examples and features of the instant solution. Referring to FIG. 2E, in some cases, the LLM 230 may not be able to match the input query to an API call from among the plurality of API calls 232, 233, 234, and 235 shown in FIG. 2B. In this case, the LLM 230 may transmit the query to an additional LLM 240 which can generate additional dialog to help the LLM 230 understand which query type (API call) the user is attempting to interact with. In this case, the LLM 240 can receive the query and prompts from a prompt database 244 and generate one or more prompts that are displayed via the software application 221.

For example, the one or more prompts may be output on a display screen 212 of the user device 210. The user may input one or more answers to the one or more prompts and submit the one or more answers to the software application 221. In response the software application 221 may pass the answers (and the previous conversation state) to the LLM 230. Here, the LLM 230 may attempt to identify the API call again, using the newly obtained data from the answers. If the API call can be identified, the process proceeds as discussed previously in FIG. 2B. If, however, an API call still cannot be identified, the LLM 230 may transmit the query and the answers to the LLM 240 for additional rounds of dialog. This process may be repeated until the LLM 230 obtains the data necessary for selecting an API call.

FIG. 2F illustrates a process 200F of identifying missing parameters from an API call according to examples and features of the instant solution. Referring to FIG. 2F, in some embodiments, the API call may be identified, but the slots for the parameters of the API call may not be capable of being filled by the data within the query. For example, the LLM 230 may transfer an identifier of the API call along with the query to the LLM 231. Here, the LLM 231 may not be able to find at least one parameter value required for filling the slots of the API call. The LLM 231 has multiple options for filling the slots when the LLM 231 is unable to find the necessary data values from the query.

For example, the LLM 231 may access a memory 246 with the previous conversation state of the user (of the user device 210) to identify whether the parameter values are available within the previous conversation state. If they are available, the LLM 231 can fill the slots and execute the API call thereby calling a downstream prescriptive AI model to generate a response. If, however, the LLM 231 is still unable to fill at least one slot of at least one parameter value, the LLM 231 can send an identifier of the API call and the query to the LLM 240 which can generate additional dialog to draw out the missing parameter value(s) from the user. In this case the LLM 240 may generate one or more questions which ask for the parameter values that are missing, and submit the questions to the software application 221. In response, the software application 221 may output the questions to the display screen 212 of the user device 210.

The user device 210 may respond with answers to the questions which are then forwarded by the software application 221 to the LLM 231. The LLM 231 may again attempt to find the parameter values (fill the slots) using the query and the answers provided by the user. If the parameter values are present, the slots may be filled and the API call executed. If, however, the slots still cannot be completely filled, the process may be repeated until the LLM 231 has the necessary slots filled for executing the API function call.

Detailed descriptions of training an artificial intelligence (AI) model and executing the AI model are further described and depicted herein. For example, the AI model may include a large language model (LLM), or the like.

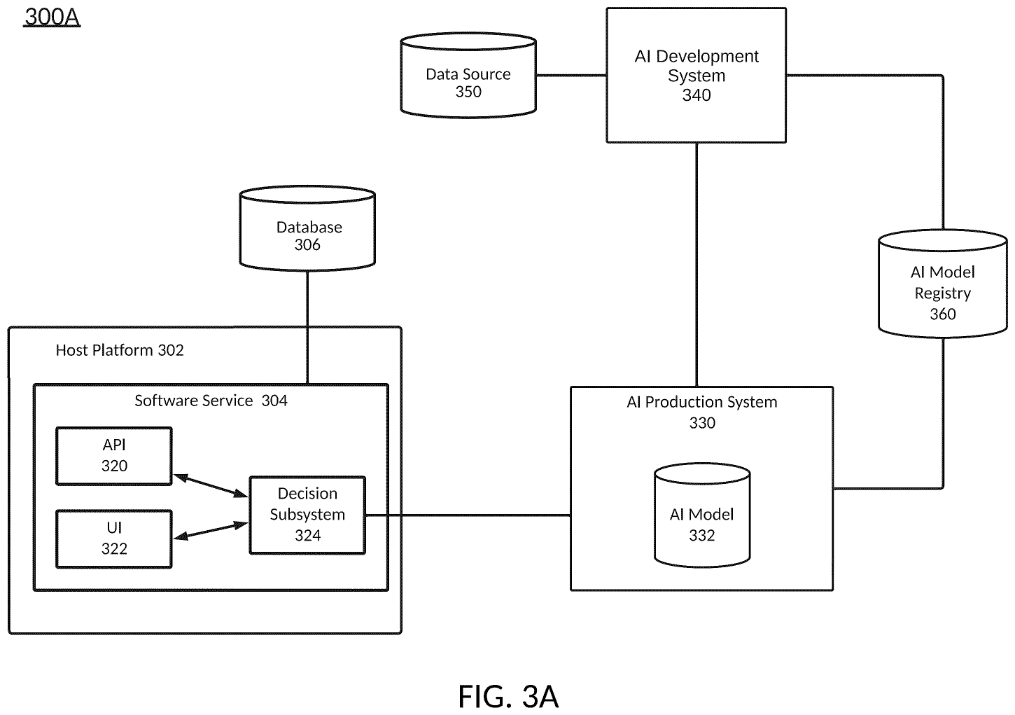

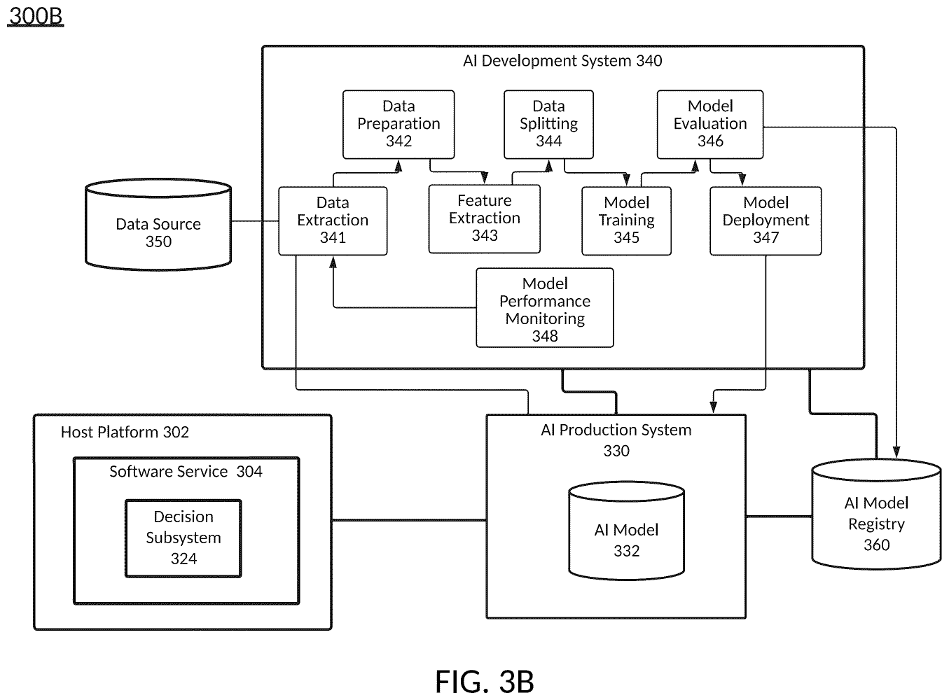

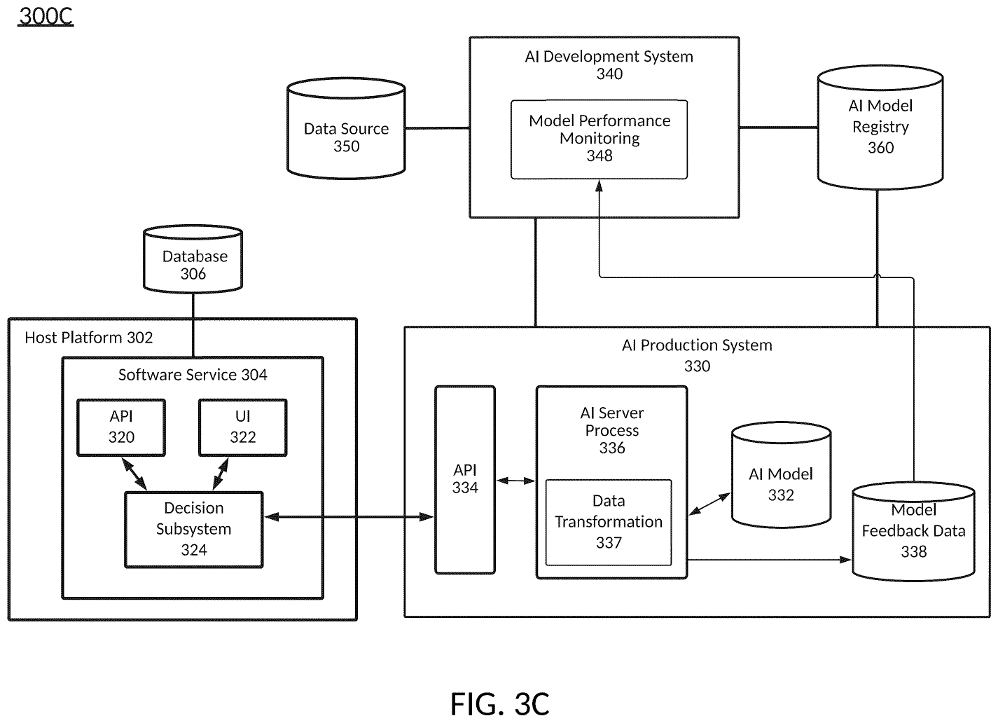

FIG. 3A illustrates an artificial intelligence (AI) network diagram 300A that supports AI-assisted decision points in a software service executing on a computer. As one example, the AI model being trained in the examples herein may refer to an LLM used for intent classification and/or slot filling in the example embodiments. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 304 (see FIG. 3A), executing on host platform 302 (see FIG. 3A) may provide one or more application programming interfaces (APIs) 320 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 320 send data to one or more decision subsystems 324 of the software service 304 to assist in decision-making. In some examples and features of the instant solution, the software service 304 stores data included in API requests or data generated during processing the API requests into one or more databases 306 (see FIGS. 1, 3A).

Software service 304 may provide one or more user interfaces (UIs) 322, such as a server-side hosted graphical user interface (GUI). In some examples and features of the instant solution, the UIs 322 provided employ template-based frameworks, component-based frameworks, etc. In some examples and features of the instant solution, these UIs 322 send data to one or more decision subsystems 324 of the software service 304 to assist with decision-making. In some examples and features of the instant solution, the software service 304 stores data included in UI requests or data generated during processing the UI requests into one or more databases 306.

Software service 304 may include one or more decision subsystems 324 that drive a decision-making process of the software service 304. In some examples and features of the instant solution, the decision subsystems 324 receive data from one or more APIs 320 as input into the decision-making process. In some examples and features of the instant solution, a decision subsystem 324 may receive data from one or more UIs 322 as input to the decision-making process. A decision subsystem 324 may gather service configuration or historical execution data from one or more databases 306 to aid in the decision-making process. A decision subsystem 324 may provide feedback to an API 320 or a UI 322.

An AI production system 330 may be used by a decision subsystem 324 in a software service 304 to assist in its decision-making process. The AI production system 330 includes one or more AI models 332 that are executed to generate a response, such as, but not limited to, a prediction, a categorization, a UI prompt, etc. In some examples and features of the instant solution, an AI production system 330 is hosted on a server. In some examples and features of the instant solution, the AI production system 330 is cloud-hosted. In some examples and features of the instant solution, the AI production system 330 is deployed in a distributed multi-node architecture.

An AI development system 340 creates one or more AI models 332. In some examples and features of the instant solution, the AI development system 340 utilizes data from one or more data sources 350 to develop and train one or more AI models 332. The data sources 350 may be local or third-party data sources. Further, the data provided by the data sources may be real-world or synthetic. In some examples and features of the instant solution, the AI development system 340 utilizes feedback data from one or more AI production systems 330 for new model development and/or existing model re-training. In some examples and features of the instant solution, the AI development system 340 resides and executes on a server. In some examples and features of the instant solution, the AI development system 340 is cloud hosted. In some examples and features of the instant solution, the AI development system 340 is deployed in a distributed multi-node architecture. In some examples and features of the instant solution, the AI development system 340 utilizes a distributed data pipeline/analytics engine.

Once an AI model 332 has been trained and validated in the AI development system 340, it may be stored in an AI model registry 360 for retrieval by either the AI development system 340 or by one or more AI production systems 330. The AI model registry 360 resides in a dedicated server in one example of the instant solution. In some examples and features of the instant solution, the AI model registry 360 is cloud-hosted. In some examples and features of the instant solution, the AI model registry 360 resides in the AI production system 330. In some examples and features of the instant solution, the AI model registry 360 is a distributed database.

FIG. 3B illustrates a process 300B for developing one or more AI models that support AI-assisted decision points. An AI development system 340 executes steps to develop an AI model 332 that begins with data extraction 341, in which data is loaded and ingested from one or more data sources 350. In some examples and features of the instant solution, historical model feedback data is extracted from one or more AI production systems 330.

Once the data has been extracted during data extraction 341, it undergoes data preparation 342 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 342 may be a manual process or an automated process using one or more of the elements and/or functions described and/or depicted herein.

Features of the data are identified and extracted during the feature extraction step 343. In some examples and features of the instant solution, a feature of the data is internal to the prepared data from the data preparation step 342. In some examples and features of the instant solution, a feature of the data requires a piece of prepared data from the data preparation step 342 to be enriched by data from another data source to be useful in developing the AI model 332. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 332.

The dataset output from the feature extraction step 343 is split 344 into a training and validation data set. The training data set is used to train the AI model 332, and the validation data set is used to evaluate the performance of the AI model 332 on unseen data.

The AI model 332 is trained and tuned 345 using the training data set from the data splitting step 344. In this step, the training data set is provided to an AI algorithm and an initial set of algorithm parameters which may be automatically determined based on the interdependence between the relevant attributes determined according to various embodiments. The performance of the AI model 332 is then tested within the AI development system 340 utilizing the validation data set from step 344. These steps may be repeated with adjustments to one or more algorithm parameters until the model's performance is acceptable based on various goals and/or results.

The AI model 332 is evaluated 346 in a staging environment (not shown) that resembles the target AI production system 330. This evaluation uses a validation dataset to ensure the performance in an AI production system 330 matches or exceeds expectations. In some examples and features of the instant solution, the validation dataset from step 344 is used. In some examples and features of the instant solution, one or more unseen validation datasets are used. In some examples and features of the instant solution, the staging environment is part of the AI development system 340, and the staging environment is managed separately from the AI development system 340. Once the AI model 332 has been validated, it is stored in an AI model registry 360, where it can be retrieved for deployment and future updates. In some examples and features of the instant solution, the model evaluation step 346 may be a manual process or an automated process using one or more of the elements and/or functions described and/or depicted herein.

In some examples and features of the instant solution, the AI development system includes a user interface (not shown). The user interface may be used to manage the development system infrastructure, the steps 341-348 within the development system, the interim data transmitted between the various steps 341-348, and the data sources 350.

Once an AI model 332 has been validated and published to an AI model registry 360, it may be deployed during the model deployment step 347 to one or more AI production systems 330. In some examples and features of the instant solution, the performance of deployed AI model 332 is monitored 348 by the AI development system 340. In some examples and features of the instant solution, AI model 332 feedback data is provided by the AI production system 330 to enable model performance monitoring 348, and the AI development system 340 periodically requests feedback data for model performance monitoring 348, which includes one or more triggers that result in the AI model 332 being updated by repeating steps 341-348 with updated data from one or more data sources 350.

FIG. 3C illustrates a process 300C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 3C, an AI production system 330 may be used by a decision subsystem 324 in software service 304 to assist in its decision-making process. The AI production system 330 provides an API 334, executed by an AI server process 336 through which requests can be made. In some examples and features of the instant solution, a request may include an AI model 332 identifier to be executed based on the type of request. In some examples and features of the instant solution, a data payload (e.g., to be input to the AI model during execution) is included in the request. The data payload may include API 320 data from software service 304, UI 322 data from software service 304 or data from other software service 304 subsystems (not shown).

Upon receiving the API 334 request, the AI server process 336 may transform 337 the data payload or portions of the data payload to be valid feature values in an AI model 332. Data transformation 337 may include, but is not limited to, combining data values, normalizing data values, and enriching the incoming data with data from other data sources 350. Once the data transformation occurs, the AI server process 336 executes the appropriate AI model 332 using the transformed input data. Upon receiving the execution result, the AI server process 336 responds to the API requester, which is a decision subsystem 324 of software service 304. In some examples and features of the instant solution, the response may result in an update to a UI 322 in software service 304. In some examples and features of the instant solution, the response includes a request identifier that can be used later by the software service 304 to provide feedback on the performance of the AI model 332. In some examples and features of the instant solution, a model feedback record may be added into a model feedback data 338 by the AI server process 336.

In some examples and features of the instant solution, the API 334 includes an interface to provide AI model 332 feedback after an AI model 332 execution response has been processed. This mechanism enables the requester to provide feedback on the accuracy of the AI model 332 results. In some examples and features of the instant solution, the feedback interface includes the identifier of the initial request so that it can be used to associate the feedback with the request. Upon receiving a call into the feedback interface of the API 334, the AI server process 336 creates and adds a model feedback record into the model feedback data 338 which holds historical model feedback records. In some examples and features of the instant solution, the records in this model feedback data 338 are provided to model performance monitoring 348 in the AI development system 340. This model feedback data is streamed to the AI development system 340 or may be provided upon request. In some examples and features of the instant solution, the model feedback records in the model feedback data 338 are used as an input for retraining the AI model 332.

In some examples and features of the instant solution, the AI production system 330 includes a user interface (not shown). The user interface may be used to manage the production system infrastructure, the components of the production system 330-338, and the operation of the AI production system and its components.

The LLMs that are used with the AI agent described herein may be trained and executed according to the examples shown and described with respect to FIGS. 3A-3C.

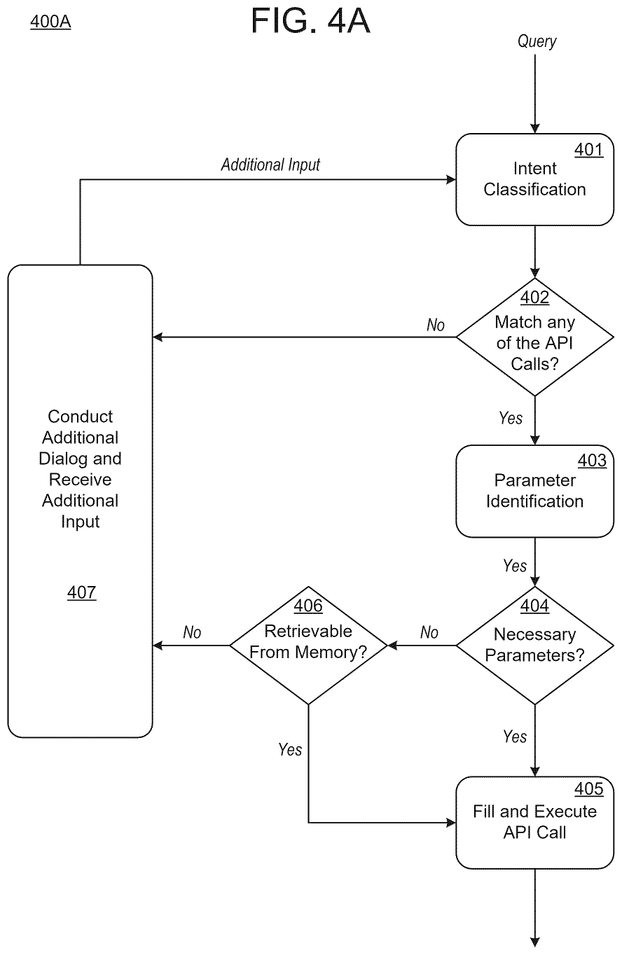

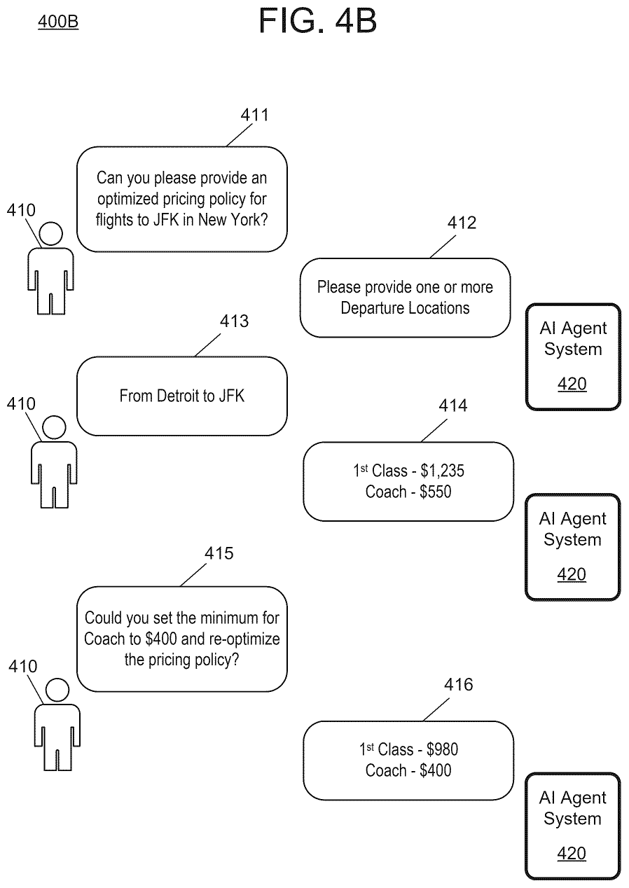

FIG. 4A illustrates a process 400A of generating a response to a natural language query according to examples of the features of the instant solution. The process 400A shown in FIG. 4A may be performed by the AI agent 222 shown and described with respect to the examples in FIGS. 2A-2F. Referring to FIG. 4A, a natural language query can be provided, for example, from a user device. In 401, an intent classification of the natural language query can be performed by a LLM. In this example, the LLM may attempt to match the natural language query to an API call from among a plurality of API calls. In 402, the process may determine whether the LLM is able to match the query to any of the API calls. If the process is unable to match the query to any of the API calls, the process may skip to step 407 and generate additional dialog to be output during the conversation with the user.

If, however, the process is able to match the query to an API call in 402, the process may perform parameter identification in 403. In this example, a second LLM may attempt to find parameter values for filling slots of an API call function using text values in the natural language query. In 404, the process may determine whether or not all required slots of the API call have been filled with parameter values using the query. If the process determines that all required slots are filled, in 405, the process executes the API call to generate a response to the natural language query and outputs the response to the conversation with the user.

If, however, in 404 the process determines that one or more slots have not been filled, in 406, the process attempts to retrieve one or more missing parameter values for the one or more slots from a memory which stores a previous conversation state from the conversation with the user. If the process is able to retrieve the one or more missing values and fill the one or more slots, the API call is executed in 405. If, however, the process is unable to retrieve the one or more missing values from the memory, in 406, the process moves to step 407 and generates additional dialog to be output during the conversation with the user.

The process shown in FIG. 4A may be repeated until the API call is executed in 405. For example, if the process has to terminate early at any of steps 402 and 406, and ask for additional data from the user, the process can repeat until enough data is provided to generate the API call and generate a response from a downstream prescriptive AI model.

FIG. 4B illustrates an example of a conversation 400B performed using an AI agent 420 according to examples of the features of the instant solution. For example, the AI agent 420 may correspond to the AI agent 222 shown and described with respect to the examples of FIGS. 2A-2F. The AI agent 222 may converse with a user 410 via the conversation. In this example, the conversation may be displayed on a chat window (not shown) of the software application accessible to a device of the user 410.

Referring to FIG. 4B, the user 410 initially asks for an optimized pricing policy for a destination (JFK airport) in a natural language input 411. In response, the AI agent 420 determines that the query matches an API call (pricing policy) but that one or more parameter values necessary for filling one or more slots of the API call are missing. In this case, the natural language input 411 is missing a departure location. Here, the AI agent can generate a response 412 with a question for the user to answer about the departure location. In response, the user may submit an answer (natural language input 413) which can be used by the AI agent 420 to fill in the missing slot, and make the necessary API call to the downstream prescriptive AI model responsible for generating the optimized pricing policy 414.

Next, the user 410 asks an additional query 415 for additional information about the pricing policy. In this case, the AI agent 420 may determine that the additional query 415 corresponds to the pricing policy API. However, the AI Agent 420 may not have enough information to fill in the slots of the API call because a departure location and a destination location are missing. In this case, the AI agent 420 may find the missing data from a memory that holds the previous conversation state (including natural language inputs 411 and 413), fill the slots of the API call, and execute the API call without a need to ask the user for additional information. Rather, the AI agent 420 generates a response 416.

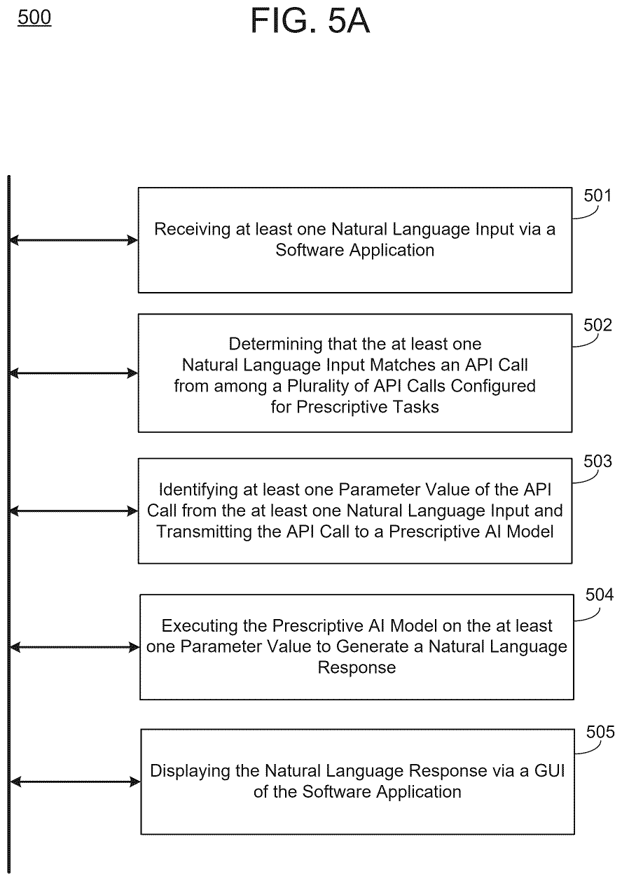

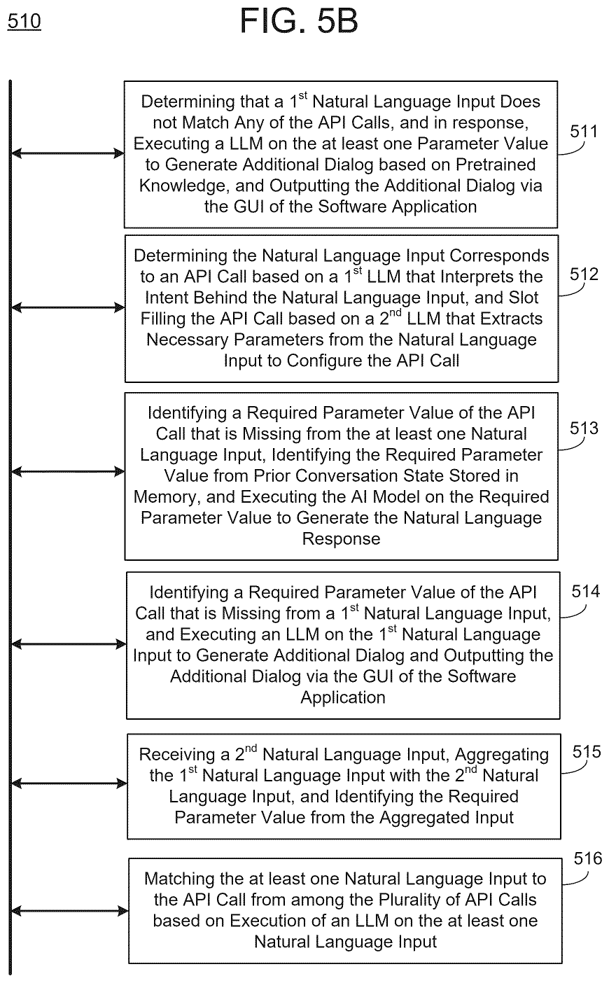

FIG. 5A illustrates a flow diagram of a method 500, according to example embodiments. Referring to FIG. 5A, the method 500 may include receiving at least one natural language input via a software application in 501. In 502, the method may include determining that the at least one natural language input matches an application programming interface (API) call from among a plurality of API calls configured for prescriptive tasks including causal analysis and decision-making. In 503, the method may include identifying at least one parameter value of the API call from the at least one natural language input and transmitting the API call to a prescriptive artificial intelligence (AI) model. In 504, the method may include executing the prescriptive AI model on the at least one parameter value to generate a natural language response. In 505, the method may include displaying the natural language response via a graphical user interface (GUI) of the software application.

FIG. 5B illustrates a flow diagram of a method 510, according to example embodiments. Referring to FIG. 5B, the method 510 may include determining that a first natural language input does not match any of the plurality of API calls, and in response, executing a large language model (LLM) on the at least one parameter value to generate additional dialog based on its pretrained knowledge and outputting the additional dialog via the GUI of the software application in 511. In 512, the method may include determining that the natural language input corresponds to an API call based on a first large language model (LLM) that interprets the intent behind the natural language input, and slot filling the API call based on a second LLM that extracts the necessary parameters from the natural language input to configure the API call.

In 513, the method may include identifying a required parameter value of the API call that is missing from the at least one natural language input, and in response, identifying the required parameter value from prior conversation state stored within a memory and executing the prescriptive AI model on the required parameter value to generate the natural language response. In 514, the method may include identifying a required parameter value of the API call that is missing from a first natural language input, and in response, executing a large language model (LLM) on the first natural language input to generate additional dialog and outputting the additional dialog via the GUI of the software application.

In 515, the method may include receiving a second natural language input via the software application and aggregating the first natural language input with the second natural language input to generate an aggregated input, wherein the identifying comprises identifying the required parameter value from the aggregated input. In 516, the method may include matching the at least one natural language input to the API call from among the plurality of API calls based on execution of a large language model (LLM) on the at least one natural language input.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
receiving at least one natural language input via a software application;
determining that the at least one natural language input matches an application programming interface (API) call from among a plurality of API calls configured for prescriptive tasks;
identifying at least one parameter value of the API call from the at least one natural language input and transmitting the API call to a prescriptive artificial intelligence (AI) model;
executing the prescriptive AI model on the at least one parameter value to generate a natural language response; and
displaying the natural language response via a graphical user interface (GUI) of the software application.

2. The computer-implemented method of claim 1, comprising determining that a first natural language input does not match any of the plurality of API calls, and in response, executing a large language model (LLM) on the at least one parameter value to generate additional dialog based on its pretrained knowledge and outputting the additional dialog via the GUI of the software application.

3. The computer-implemented method of claim 2, wherein the determining comprises determining that the first natural language input corresponds to an API call based on a first large language model (LLM) that interprets an intent behind the first natural language input, and slot filling the API call based on a second LLM that extracts the at least one parameter value from the first natural language input to configure the API call.

4. The computer-implemented method of claim 1, comprising identifying a required parameter value of the API call that is missing from the at least one natural language input, and in response, identifying the required parameter value from prior conversation state stored within a memory and executing the prescriptive AI model on the required parameter value to generate the natural language response.

5. The computer-implemented method of claim 1, comprising identifying a required parameter value of the API call that is missing from a first natural language input, and in response, executing a large language model (LLM) on the first natural language input to generate additional dialog and outputting the additional dialog via the GUI of the software application.

6. The computer-implemented method of claim 5, comprising receiving a second natural language input via the software application and aggregating the first natural language input with the second natural language input to generate an aggregated input, wherein the identifying comprises identifying the required parameter value from the aggregated input.

7. The computer-implemented method of claim 1, wherein the determining comprises matching the at least one natural language input to the API call from among the plurality of API calls based on execution of a large language model (LLM) on the at least one natural language input.

8. A computer system comprising:
a processor set;
a set of one or more computer-readable storage media; and
program instructions, collectively stored in the set of one or more storage media, for causing the processor set to perform computer operations comprising:
receive at least one natural language input via a software application,
determine that the at least one natural language input matches an application programming interface (API) call from among a plurality of API calls configured for prescriptive tasks,
identify at least one parameter value of the API call from the at least one natural language input and transmit the API call to a prescriptive artificial intelligence (AI) model,
execute the prescriptive AI model on the at least one parameter value to generate a natural language response, and
display the natural language response via a graphical user interface (GUI) of the software application.

9. The computer system of claim 8, wherein the computer operations comprise determine that a first natural language input does not match any of the plurality of API calls, and in response, execute a large language model (LLM) on the at least one parameter value to generate additional dialog based on its pretrained knowledge and output the additional dialog via the GUI of the software application.

10. The computer system of claim 9, wherein the determination comprises determine that the first natural language input corresponds to an API call based on a first large language model (LLM) that interprets an intent behind the first natural language input, and slot fill the API call based on a second LLM that extracts the at least one parameter value from the first natural language input to configure the API call.

11. The computer system of claim 8, wherein the computer operations comprise identify a required parameter value of the API call that is missing from the at least one natural language input, and in response, identify the required parameter value from prior conversation state stored within a memory and execute the prescriptive AI model on the required parameter value to generate the natural language response.

12. The computer system of claim 8, wherein the computer operations comprise identify a required parameter value of the API call that is missing from a first natural language input, and in response, execute a large language model (LLM) on the first natural language input to generate additional dialog and output the additional dialog via the GUI of the software application.

13. The computer system of claim 12, wherein the computer operations comprise receive a second natural language input via the software application and aggregate the first natural language input with the second natural language input to generate an aggregated input, wherein the identification comprises the required parameter value from the aggregated input.

14. The computer system of claim 8, wherein the determination comprises a match of the at least one natural language input to the API call from among the plurality of API calls based on execution of a large language model (LLM) on the at least one natural language input.

15. A computer program product comprising:
a set of one or more computer-readable storage media; and
program instructions, collectively stored in the set of one or more computer-readable storage media, for causing a processor set to perform computer operations comprising:
receiving at least one natural language input via a software application;
determining that the at least one natural language input matches an application programming interface (API) call from among a plurality of API calls configured for prescriptive tasks;
identifying at least one parameter value of the API call from the at least one natural language input and transmitting the API call to a prescriptive artificial intelligence (AI) model;
executing the prescriptive AI model on the at least one parameter value to generate a natural language response; and
displaying the natural language response via a graphical user interface (GUI) of the software application.

16. The computer program product of claim 15, wherein the computer operations comprise determining that a first natural language input does not match any of the plurality of API calls, and in response, executing a large language model (LLM) on the at least one parameter value to generate additional dialog based on its pretrained knowledge and outputting the additional dialog via the GUI of the software application.

17. The computer program product of claim 16, wherein the determining comprises determining that the first natural language input corresponds to an API call based on a first large language model (LLM) that interprets an intent behind the first natural language input, and slot filling the API call based on a second LLM that extracts the at least one parameter value from the first natural language input to configure the API call.

18. The computer program product of claim 15, wherein the computer operations comprise identifying a required parameter value of the API call that is missing from the at least one natural language input, and in response, identifying the required parameter value from prior conversation state stored within a memory and executing the prescriptive AI model on the required parameter value to generate the natural language response.

19. The computer program product of claim 15, wherein the computer operations comprise identifying a required parameter value of the API call that is missing from a first natural language input, and in response, executing a large language model (LLM) on the first natural language input to generate additional dialog and outputting the additional dialog via the GUI of the software application.

20. The computer program product of claim 19, wherein the computer operations comprise receiving a second natural language input via the software application and aggregating the first natural language input with the second natural language input to generate an aggregated input, wherein the identifying comprises identifying the required parameter value from the aggregated input.
